(19) United States
(12) Patent Application Publication
(10) Pub. No.: US 2012/0316914 A1
(43) Pub. Date: Dec. 13, 2012

(54) SCHEDULING OF ENERGY CONSUMING ACTIVITIES FOR BUILDINGS

(75) Inventors: Young Min Lee, Old Westbury, NY (US); Chandrasekhara K. Reddy, Kinnelon, NJ (US)

(73) Assignee: INTERNATIONAL BUSINESS MACHINES CORPORATION, Armonk, NY (US)

(21) Appl. No.: 13/156,997

(22) Filed: Jun. 9, 2011

(51) Int. Cl. G06Q 10/00

(52) U.S. Cl. 705/7.24

(57) ABSTRACT

Scheduling of building activities may be generated based on an objective function developed to optimize energy cost associated with performing activities in a building, which activities consume energy. The objective function may be solved based on the received plurality of activities, the energy sources consumed by the activities, the prices of energy, and subject to the one or more constraints.

### FIELD

The present application relates generally to thermal properties of a building, and more particularly to estimating building thermal properties by integrating heat transfer inversion model with clustering and regression techniques for a portfolio of existing buildings.

### BACKGROUND

Saving energy, improving energy efficiency and reducing greenhouse gas (GHG) emissions are key initiatives in many cities and municipalities and for building owners and operators. The inventors in this disclosure have recognized that to reduce energy consumption in buildings, one should understand how heat is transferred from outside to inside the buildings to various zones and heating, ventilating, and air conditioning (HVAC) systems. For instance, one should understand the heat conduction, convection, radiation, latent heat, sensible heat, heat transfer through walls, windows, roofs and infiltration, and others about the building. In addition, well-planned schedule of activities in the building would reduce energy costs and green house gas emissions.

### BRIEF SUMMARY

A method for scheduling of energy consuming activities in a building, in one aspect, may include receiving a plurality of activities to schedule in a building, the activities which consume energy from multiple sources having different generation and storage modes and price structures and receiving one or more constraints associated with the activities, energy sources consumed by the activities, and cost of the energy sources. The method may also include solving an objective function, by a processor, that optimizes energy cost associated with performing the activities based on the received plurality of activities, the energy sources consumed by the activities, and subject to the one or more constraints. The method may further include determining a schedule of the activities based on the solved objective function.

A system for scheduling of energy consuming activities in a building, in one aspect, may include a module operable to execute on the process and further operable to receive a plurality of activities to schedule in a building, the activities which consume energy from multiple sources having different generation and storage modes and price structures. The module may be further operable to receive one or more constraints associated with the activities, energy sources consumed by the activities, and cost of the energy sources. The module may be also operable to solve an objective function that optimizes energy cost associated with performing the activities based on the received plurality of activities, the energy sources consumed by the activities, and subject to the one or more constraints. The module may be further operable to determine a schedule of the activities based on the solved objective function.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a block diagram illustrating a methodology of the present disclosure in one embodiment for scheduling of energy consuming activities for buildings.

FIG. 2 is a flow diagram illustrating a method of the present disclosure in one embodiment for scheduling of energy consuming activities for buildings.

FIG. 3 illustrates components of a system which may implement the methodologies of the present disclosure in one embodiment.

### DETAILED DESCRIPTION

In one embodiment of the present disclosure, a methodology is presented for scheduling of activities in a building, where activities contribute to consumption of energy from multiple sources, the energy sources having different generation and storage modes and price structures. The scheduling of activities in one embodiment of the present disclosure is integrated with scheduling of generation and procurement of energy sources while satisfying scheduling constraints on the activities and optimizing for energy costs, including monetary cost and green house gas emissions.

Energy sources such as electricity may be variably priced, for example, prices may vary by the time of the day and/or by level of consumption. Demand charges for a consumer may vary depending on whether the demand occurred during the peak demand period. Activities may be scheduled so that the demand curve is flat, also known as peak shaving.

Buildings or facilities often use multiple energy sources, for example, electricity, natural gas, oil, co-generation plants, wind and solar. Different energy sources can be used for the same purpose, for example, electricity, oil, steam from co-generation plants for heating. Some energy sources satisfy multiple needs, for example, co-generation plants produce electricity and heat/steam as a by product. Different energy sources have different price structures and different green house gas emission amount.

Oil and gas are stored in storage units or containers such as tanks. Prices of these commodities vary seasonally and in some cases more often. Scheduling of energy procurement or replenishment may leverage the price structure to optimize the energy cost. Moreover, turning on and off of generators in co-generation plants may be scheduled to offset other energy costs.

Scheduling of activities in a building also needs to take into account the availability resources such as the room, laboratory, facility or others. Activity dependencies and time restrictions also need to be considered. Replanning of schedules takes into consideration changes in activity requirements and energy prices. Energy consumption by activity may be determined by activity per unit time.

A methodology of the present disclosure in one embodiment considers all the above factors in scheduling one or more activities in a building so as to minimize the energy cost and/or green house gas emitted by the buildings consuming energy. For instance, a method of the present disclosure in one embodiment considers energy costs of multiple energy sources of different types to determine schedule of activities, energy generation and procurement that minimizes energy cost which may include both monetary and GHG emissions. A method of the present disclosure in one embodiment also may integrate optimal activity scheduling with optimal energy generation and procurement. A method of the present disclosure in one embodiment further may integrate activity scheduling and multiple sourcing of energy for optimizing energy cost and minimizing green house gas emission. Rescheduling may be also provided.

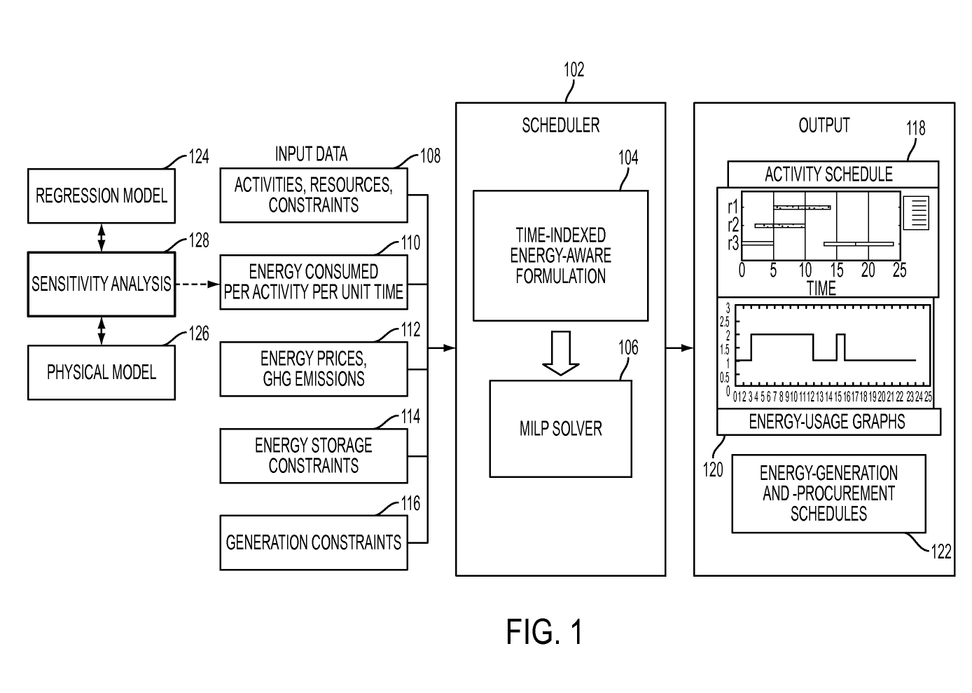

FIG. 1 is a block diagram illustrating a methodology of the present disclosure in one embodiment. A scheduler 102 of the present disclosure in one embodiment may include a time-indexed energy-aware formulation 104 and a mixed integer linear programming (MILP) solver 106. The time-indexed energy-aware formulation 104, in one embodiment includes an objective function for optimization, also referred to as an optimization model or a model. The MILP solver 106 is a tool that solves a linear programming problem, given an objective function and one or more constraints. The scheduler 102 takes data inputs such as activities, resources, and constraints 108, energy consumed per activity per unit time 110, energy prices, GHG emissions 112, energy storage constraints 114 and energy generation constraints 116. The scheduler 102 may generate as outputs activity schedule 118, energy usage graphs 120, and energy-generation and energy-procurement schedules 122.

In one embodiment of the present disclosure, the energy consumed per activity per unit time 110 may be determined based on a regression model 124, a physical model 126 and sensitivity analysis performed 128.

In one embodiment of the present disclosure, the time-indexed energy-aware formulation 104 is an optimization model. The decision variables to the time-indexed formulation 102 may include:

aᵢᵣₑₜ representing whether activity i is scheduled on resource r using energy type e starts at time t; for example, whose value is 1 if activity i is scheduled on resource r using energy type e starts at time t;

pₑₜ which represents the number of units of peak total energy usage of energy type e at time t;

plₑₗₜ representing whether total energy usage for energy type e at time t is at peak level l, for example, whose value is 1 if total energy usage for energy type e at time t is at peak level l;

rlₑₜ which represents reservoir level for energy type e at time t;

rrₑₜ which represents reservoir refill amount for energy type e at time t;

gₙₜ representing whether generator n is operational at time t, for example, whose value is 1 if generator n is operational at time t; 0, otherwise.

Briefly, a decision variable is an unknown in an optimization problem, which can be controlled. The time-indexed energy-aware formulation 104 finds values for the decision variables that satisfy all constraints and optimize a specific objective function.

The inputs to the time-indexed energy-aware formulation 104 may include:

E_{irct} the number of units of energy of type e needed by activity i on resource r at time t (e.g., FIG. 1 at 110);
RRₑ^{min} minimum amount of refill for reservoir of energy type e (e.g., FIG. 1 at 114);
RRₑ^{max} maximum amount of refill for reservoir of energy type e (e.g., FIG. 1 at 114);
RLₑ^{min} minimum level to be maintained for reservoir of energy type e (e.g., FIG. 1 at 114);
RLₑ^{max} maximum level to be maintained for reservoir of energy type e (e.g., FIG. 1 at 114);
RCₑₜ cost per unit for refilling reservoir of energy type e at time t (e.g., FIG. 1 at 112);
Cₑₗₜ cost of energy type e at peak level l at time t (e.g., FIG. 1 at 112);
Gₙₑ the number of units of energy type e generated by generator n (e.g., FIG. 1 at 116);
ESTᵢ, LFTᵢ allowed time window for activity i (e.g., FIG. 1 at 108)
Rᵢ set of allowed resources for activity i (e.g., FIG. 1 at 108);
Dᵢ duration of activity i; (e.g., FIG. 1 at 108)
Aᵣ activities schedulable on resource r (e.g., FIG. 1 at 108)
IRLₑ initial resource level for energy type e (e.g., FIG. 1 at 114).

The following are one or more model constraints that are taken into account in scheduling building activities in one embodiment of the present disclosure.

An activity takes place within its time window, expressed as:

aᵢᵣₑₜ=0 if t∉[ESTᵢ,LFTᵢ] (1)

Time may be expressed in units of hours, half-hours or any other level of precision desired. The above constraint, for example, determines if an activity should start at certain time, for example, between hour 1 and 3.

An activity is scheduled at most once, expressed as:

ΣᵢΣ_{r∈R}_{ᵢ}Σ_{t∈[EST}_{ᵢ}_{,LFT}_{ᵢ}_{]}aᵢᵣₑₜ≦1 (2)

If an activity starts at time t₁ on a resource, then no other activity is scheduled on the resource until the end of its duration, expressed as

aᵢᵣₑₜ_{₁}=1 [symbol] Σᵢ_{₁}_{∈A}_{ᵣ}Σₜ₌ₜ_{₁}^{t}^{₁}^{+D}^{ᵢ}aᵢ_{₁}ᵣₜ=1,i∈Aᵣ,t₁∈[ESTᵢ,LFTᵢ−Dᵢ] (3)

The sum of energy generated by generators and the other energy sources of the same type should be at least as much as the demand from the activities, expressed as

pₑₜ+ΣₙGₙₑ·gₙₜ≧ΣᵢΣ_{r∈R}_{ᵢ}Eᵢᵣₑₜ·aᵢᵣₑₜ_{₁}, where t∈[t₁,t₁+Dᵢ] (4)

Peak level energy usage, expressed as

pₑₜ=l [symbol] plₑₗₜ=1 (5)

Initial resource levels, expressed as

rlₑ₀=IRLₑ (6)

Conservation equation, which says reservoir level at time t is equivalent to reservoir level at time t−1 plus the replenished quantity at t−1 minus the energy used at t−1, is expressed as

rlₑₜ=rlₑₜ₋₁+rrₑₜ₋₁−pₑₜ₋₁,t≧1 (7)

Limits on resource levels, expressed as

RLₑ^{min}≦rlₑₜ≦RLₑ^{max} (8)

Minimum and maximum amount of resource replenishments, expressed as

rrₑₜ≧1 [symbol] rrₑₜ≧RRₑ^{min} (9)

rrₑₜ≦RRₑ^{max} (10)

An objective function (e.g., FIG. 1 102), in one embodiment may include:

$$minimize \underbrace{{Σ}_{e} {Σ}_{l} {Σ}_{t} {pl}_{elt} {C}_{elt}}_{peak level cost} + \underbrace{{Σ}_{e} {Σ}_{t} {rr}_{et} {RC}_{et}}_{resources filling cost } + \underbrace{{Σ}_{n} {Σ}_{t} {GC}_{n t} {g}_{n t}}_{generator cost} \qquad ( 11 )$$

The above objective function may be solved to determine:

aᵣᵢₑₜ, representing whether an activity i starts at time t on resource r using energy type e;
rrₑₜ, representing how much reservoir for energy type e is replenished at time t;
gₙₜ, representing whether generator n is on or off at time t.

GCₙₜ represents the cost of operating generator n at time t, which in one embodiment is input to the objective function.

In one embodiment of the present disclosure, the number of units of energy of type e needed by activity i on resource r at time t (E_{irct}) may be generated based on sensitivity analysis 128 of data obtained using a regression model 124 and/or physical model 126.

In one embodiment of the present disclosure, the physical mode 126 may have the following general form:

$${R}_{wall} \to \begin{matrix}{Q}_{sys} = ( {h}_{q , wall} {A}_{wall} + {h}_{q , roof} {A}_{roof} + {h}_{q , win} {A}_{win} + {\dot{m}}_{inf} {C}_{p} ) \\ {\int }_{{t}_{0}}^{{t}_{1}} {( {T}_{z} - {T}_{amb} ( τ ) )}^{+} d τ \\ = ( \frac{{A}_{wall}}{{R}_{wall}} + \frac{{A}_{roof}}{{R}_{roof}} + \frac{{A}_{window}}{{R}_{window}} + {\dot{m}}_{inf} {C}_{p} ) \\ {\int }_{{t}_{0}}^{{t}_{1}} {( {T}_{z} - {T}_{amb} ( τ ) )}^{+} d τ\end{matrix}$$

From the above heat transfer model, Q_{sys}, which represents heat energy required to be provided to a building for requested comfort (e.g., in cooling or heating a building) may be obtained.

h_{q,wall}, h_{q,roof}, h_{q,win}, \dot{m}_{inf} denote heat transfer coefficients for wall, roof, windows and infiltration of outside air into the building respectively.
A_{wall}, A_{roof}, A_{win} denote area of wall, roof and window in a building.
Cₚ, T_{z}, T_{amb} denote specific heat of air inside building, temperature of inside of building (zone), and ambient (outside) temperature. τ is simply integration variable.
R_{wall}, R_{roof}, R_{win} denote heat resistance coefficients (reciprocal of heat transfer coefficients) of wall, roof and window respectively.

The equation above describes that the heat required to be provided to a building is equal amount of the heat needed to overcome the heat transferred from the outside air (ambient) into the inside of the building through the wall, roof, window and infiltration (open door, window and cracks in the wall etc.).

Different variations of the above model may be generated and used, for example, to model different retrofit items (e.g., other than or in addition to “wall”, “roof”, or “window”, specified in the above equation).

In one embodiment of the present disclosure, the regression model 124 may have the following general form:

$${x}_{3} -> \begin{matrix}{E}_{j , elec} = {β}_{0} + {β}_{1} {x}_{1} + {β}_{2} {x}_{2} + {β}_{3} {x}_{3} + … + {ɛ}_{elec} \\ {E}_{j , gas} = {β}_{0} + {β}_{1} {x}_{1} + {β}_{2} {x}_{2} + {β}_{3} {x}_{3} + … + {ɛ}_{gas}\end{matrix}$$

The above regression model may predict energy savings, E_{j,elect} and E_{j,gas}.

E_{j,elect} represents electric (elect) energy saved in building j.
E_{j,gas} represents gas (gas) energy saved in building j.
The above regression model may be used to predict other one or more types of energy savings, e.g., E_{j,type} where “type” refers to the type of energy.

The above models are regression models that formulate energy usage in terms of building's characteristics (xᵢ). βᵢ (where i=1, 2, 3, . . . ) represents a coefficient value (e.g., a weight value) that each building characteristic (xᵢ=x₁, x₂, x₃, . . . ) contributes to the energy usage in that building. β₀ is a constant value contributing to that building's energy usage, which is not associated with building characteristics. The regression models may be generated or developed based on historical data associated with energy usage in buildings with those building characteristics. ε (of elec (electricity) or gas or other type of energy) is an error value, which cannot be attributed to the building characteristics or other energy use in a building. The regression model provides the coefficients associated with different building characteristics based on the past usage data. The model with the determined coefficients then may be used to predict future energy usage in a building having those characteristics. Examples of building characteristics include, but are not limited to, gross floor area (GFA), age of the building and its equipment, occupancy-related data, operating hours, number of equipment, area of building cooled, area of building heated and others conditions of the building corresponding to the time period of the energy consumption data, and types of activities that may take place in the building, and other.

A sensitivity analysis 128 provides the amount of energy consumed by an activity in a resource per unit time. In one embodiment of the disclosure, either a Physical Model or a Regression Model or a combination is utilized to determine the amount of energy consumed by an activity in a resource per unit time. When the resource for an activity is a building, the regression model corresponding to the building is employed to determine the energy usage in one embodiment of the present disclosure. However, when the resource for an activity is a smaller zone of a building, the physical model of the zone is utilized to provide the energy usage in one embodiment of the present disclosure. In another embodiment of the disclosure, the energy usage information may be provided as an input.

In one aspect, optimal utilization of reservoir-type energy sources is integrated with grid-type energy sources. In another aspect, the procurement of reservoir-type energy sources is scheduled to minimize energy costs. In yet another aspect, the generation of local energy sources (e.g., generators and co-generation plants) is scheduled to minimize overall energy costs.

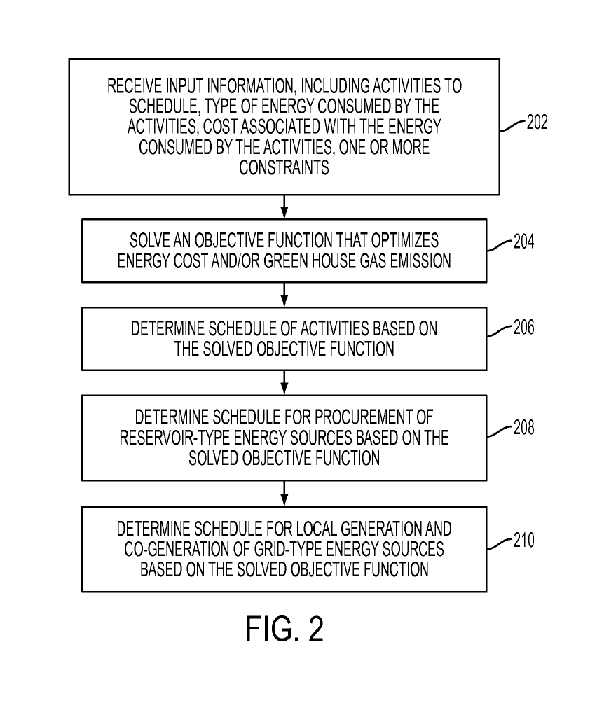

FIG. 2 is a flow diagram illustrating a method of the present disclosure in one embodiment. At 202, input information is received. Input information may include a list of activities to schedule, a list of resources needed to perform the activities and the availability of those resources, energy consumed per activity per unit time, energy prices and green house gas emission associated with energy, energy storage constraints and energy generation constraints. The input information may include energy source information associated with both reservoir-type energy sources and grid-type energy sources. Examples of the reservoir-type energy sources are oil and natural gas. An example of the grid-type energy sources is electricity.

At 204, a scheduler determines optimal schedule based on the input information and solving an integer linear programming problem, an objective function that considers energy costs of multiple energy sources of different types to determine schedules of activities, energy generation and procurement with the objective of minimizing energy cost or green house gas emission.

At 206, activity schedules are output based on the solution to the integer linear programming problem. For each activity, the schedule provides on which resource and at what time the activity is to be held. This information may be output as a Gantt chart.

In addition, energy-usage graphs and energy-generation and procurement schedule may be output. For example, at 208, a procurement schedule for reservoir-type energy sources may be obtained based on the solution to the integer linear programming problem provided by 204. For each reservoir-type energy source, the schedule provides how much units of energy need to be procured at various points in time.

At 210, a schedule for local generation and co-generation of grid-type energy sources may be determined based on the solution to the integer linear programming problem provided by 204. For each generator at each point of time, the solution determines whether the generator should be turned on or turned off.

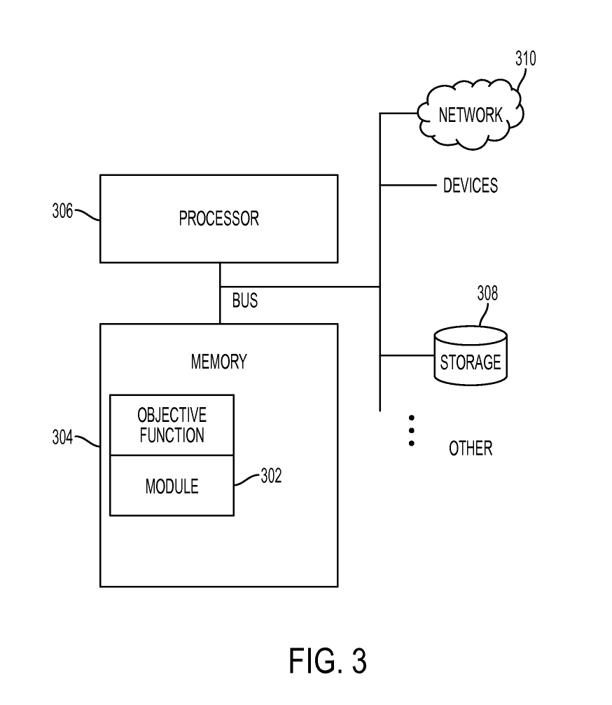

FIG. 3 illustrates components of a system which may implement the methodologies of the present disclosure in one embodiment. The system may include a processor 306 operable to execute one or more computer instructions 302 stored in memory 304 to receive input information and solve an objective function for scheduling of activities that minimizes energy cost and/or green house gas emission. In one aspect, the computer instructions and/or the objective function stored in memory 304 may be received over a network 310 and/or read from a persistent storage device 308.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for scheduling of energy consuming activities in a building, comprising:
receiving a plurality of activities to schedule in a building, the activities which consume energy from multiple sources having different generation and storage modes and price structures;
receiving one or more constraints associated with the activities, energy sources consumed by the activities, and cost of the energy sources;
solving an objective function, by a processor, that optimizes energy cost associated with performing the activities based on the received plurality of activities, the energy sources consumed by the activities, and subject to the one or more constraints; and
determining a schedule of the activities based on the solved objective function.

2. The method of claim 1, wherein the objective function is solved to minimize green house gas emitted by the activities.

3. The method of claim 1, wherein the objective function is solved to optimally utilize reservoir-type energy sources integrated with grid-type energy sources.

4. The method of claim 3, further including:
determining a schedule of procurement of reservoir-type energy sources that minimizes the energy cost based on the solved objective function.

5. The method of claim 4, further including:
determining a schedule of generation of local energy sources that minimizes the energy cost based on the solved objective function.

6. The method of claim 1, wherein the objective function includes:
$$minimize \underbrace{{Σ}_{e} {Σ}_{l} {Σ}_{t} {pl}_{elt} {C}_{elt}}_{peak level cost} + \underbrace{{Σ}_{e} {Σ}_{t} {rr}_{et} {RC}_{et}}_{resources filling cost } + \underbrace{{Σ}_{n} {Σ}_{t} {GC}_{n t} {g}_{n t}}_{generator cost}$$
wherein,
plₑₗₜ represents whether total energy usage for energy type e at time t is at peak level l;
Cₑₗₜ represents cost of energy type e at peak level l at time t;
rrₑₜ represents how much reservoir for energy type e is replenished at time t;
RCₑₜ represents cost per unit for refilling reservoir of energy type e at time t;
GCₙₜ represents the cost of operating generator n at time t;
gₙₜ represents whether generator n is on or off at time t.

7. The method of claim 6, wherein the constraints include:
aᵢᵣₑₜ=0 if t∉[ESTᵢ,LFTᵢ], representing that an activity takes place within its time window;
ΣᵢΣ_{r∈R}_{ᵢ}Σ_{[EST}_{ᵢ}_{,LET}_{ᵢ}_{]}aᵢᵣₑₜ≦1, representing that an activity is scheduled at most once;
aᵢᵣₑₜ_{₁}=1 [symbol] Σᵢ_{₁}_{∈A}_{ᵣ}Σₜ₋ₜ_{₁}^{t}^{₁}^{+D}^{ᵢ}aᵢ_{₁}ᵣₜ=1,i∈Aᵣ,t₁∈[ESTᵢ,LFTᵢ−Dᵢ], representing that if an activity starts at time t₁ on a resource, then no other activity is scheduled on the resource until the end of its duration;
pₑₜ+ΣₙGₙₑ·gₙₜ≧ΣᵢΣ_{r∈R}_{₁}Eᵢᵣₑₜ·aᵢᵣₑₜ_{₁}, where t∈[t₁,t₁+Dᵢ], representing that sum of energy generated by generators and other energy sources of the same type should be at least as much as the demand from the activities;
pₑₜ=l [symbol] plₑₗₜ=1, representing peak level energy usage;
rlₑ₀=IRLₑ, representing initial resource levels;
rlₑₜ=rlₑₜ₋₁+rrₑₜ₋₁−pₑₜ₋₁,t≧1, representing conservation equation describing that reservoir level at time t is equivalent to reservoir level at time t−1 plus the replenished quantity at t−1 minus the energy used at t−1;
RLₑ^{min}≦rlₑₜ≦RLₑ^{max}, representing limits on resource levels;
rrₑₜ≧1 [symbol] rrₑₜ≧RRₑ^{min}, representing minimum amount of resource replenishment; or
rrₑₜ≦RRₑ^{max}, representing maximum amount of resource replenishments; or
combinations thereof.

8. The method of claim 1, wherein the energy sources consumed by the activities are determined by performing sensitivity analysis of data obtained using a regression model describing energy savings in a building in terms of building characteristics, or a physical heat transfer model describing heat energy required to be provided to the building, or a combination thereof.

9. The method of claim 8, wherein the regression model includes:
E_{j,elec}=β₀+β₁x₁+β₂x₂+β₃x₃+ . . . +ε_{elec}
E_{j,gas}=β₀+β₁x₁+β₂x₂+β₃x₃+ . . . +ε_{gas}
for predicting energy savings, E_{j,eject} and E_{j,gas}, wherein
E_{j,eject} represents electric (elect) energy saved in building j;
E_{j,gas} represents gas (gas) energy saved in building j;
xᵢ represents building's characteristic i;
βᵢ represents a coefficient value that each building characteristic xᵢ contributes to the energy usage in building j;
β₀ is a constant value contributing to building j's energy usage, which is not associated with building characteristics.

10. The method of claim 8, wherein the physical heat transfer model includes:
$$\begin{matrix}{Q}_{sys} = ( {h}_{q , wall} {A}_{wall} + {h}_{q , roof} {A}_{roof} + {h}_{q , win} {A}_{win} + {\dot{m}}_{inf} {C}_{p} ) \\ {\int }_{{t}_{0}}^{{t}_{1}} {( {T}_{z} - {T}_{amb} ( τ ) )}^{+} d τ \\ = ( \frac{{A}_{wall}}{{R}_{wall}} + \frac{{A}_{roof}}{{R}_{roof}} + \frac{{A}_{window}}{{R}_{window}} + {\dot{m}}_{inf} {C}_{p} ) \\ {\int }_{{t}_{0}}^{{t}_{1}} {( {T}_{z} - {T}_{amb} ( τ ) )}^{+} d τ\end{matrix}$$
wherein,
Q_{sys}, represents heat energy required to be provided to a building;
h_{q,wall}, h_{q,roof}, h_{q,win}, \dot{m}_{inf} denote heat transfer coefficients for wall, roof, windows and infiltration of outside air into the building, respectively;
A_{wall}, A_{roof}, A_{win} denote area of wall, roof and window in the building, respectively;
Cₚ, T_{z}, T_{amb} denote specific heat of air inside building, temperature of inside of building (zone), and ambient (outside) temperature, respectively;
τ is an integration variable;
R_{wall}, R_{roof}, R_{win} denote heat resistance coefficients of wall, roof and window, respectively.

11. A computer readable storage medium storing a program of instructions executable by a machine to perform a method of scheduling of activities in a building, comprising:
receiving a plurality of activities to schedule in a building, the activities which consume energy from multiple sources having different generation and storage modes and price structures;
receiving one or more constraints associated with the activities, energy sources consumed by the activities, and cost of the energy sources;
solving an objective function, by a processor, that optimizes energy cost associated with performing the activities based on the received plurality of activities, the energy sources consumed by the activities, and subject to the one or more constraints; and
determining a schedule of the activities based on the solved objective function.

12. The computer readable storage medium of claim 12, wherein the objective function is solved to minimize green house gas emitted by the activities.

13. The computer readable storage medium of claim 12, wherein the objective function is solved to optimally utilize reservoir-type energy sources integrated with grid-type energy sources.

14. The computer readable storage medium of claim 13, further including:
determining a schedule of procurement of reservoir-type energy sources that minimizes the energy cost based on the solved objective function.

15. The computer readable storage medium of claim 14, further including:
determining a schedule of generation of local energy sources that minimizes the energy cost based on the solved objective function.

16. The computer readable storage medium of claim 10, wherein the objective function includes:
$$minimize \underbrace{{Σ}_{e} {Σ}_{l} {Σ}_{t} {pl}_{elt} {C}_{elt}}_{peak level cost} + \underbrace{{Σ}_{e} {Σ}_{t} {rr}_{et} {RC}_{et}}_{resources filling cost } + \underbrace{{Σ}_{n} {Σ}_{t} {GC}_{n t} {g}_{n t}}_{generator cost}$$
wherein,
plₑₗₜ represents whether total energy usage for energy type e at time t is at peak level l;
Cₑₗₜ represents cost of energy type e at peak level l at time t;
rrₑₜ represents how much reservoir for energy type e is replenished at time t;
RCₑₜ represents cost per unit for refilling reservoir of energy type e at time t;
GCₙₜ represents the cost of operating generator n at time t;
gₙₜ represents whether generator n is on or off at time t.

17. The computer readable storage medium of claim 16, wherein the constraints include:
aᵢᵣₑₜ=0 if t∈[ESTᵢ,LFTᵢ], representing that an activity takes place within its time window;
ΣᵢΣ_{r∈R}_{ᵢ}Σ_{t∈[EST}_{ᵢ}_{,LET}_{ᵢ}_{]}aᵢᵣₑₜ≦1, representing that an activity is scheduled at most once;
aᵢᵣₑₜ_{₁}=1 [symbol] Σᵢ_{₁}_{∈A}_{ᵣ}Σₜ₋ₜ_{₁}^{t}^{₁}^{+D}^{ᵢ}aᵢ_{₁}ᵣₜ=1,i∈Aᵣ,t₁∈[ESTᵢ,LFTᵢ−Dᵢ], representing that if an activity starts at time t₁ on a resource, then no other activity is scheduled on the resource until the end of its duration;
pₑₜ+ΣₙGₙₑ·gₙₜ≧ΣᵢΣ_{r∈R}_{₁}Eᵢᵣₑₜ·aᵢᵣₑₜ_{₁}, where t∈[t₁,t₁+Dᵢ], representing that sum of energy generated by generators and other energy sources of the same type should be at least as much as the demand from the activities;
pₑₜ=l [symbol] plₑₗₜ=1, representing peak level energy usage;
rlₑ₀=IRLₑ, representing initial resource levels;
rlₑₜ=rlₑₜ₋₁+rrₑₜ₋₁−pₑₜ₋₁,t≧1, representing conservation equation describing that reservoir level at time t is equivalent to reservoir level at time t−1 plus the replenished quantity at t−1 minus the energy used at t−1;
RLₑ^{min}≦rlₑₜ≦RLₑ^{max}, representing limits on resource levels;
rrₑₜ≧1 [symbol] rrₑₜ≧RRₑ^{min}, representing minimum amount of resource replenishment; or
rrₑₜ≦RRₑ^{max}, representing maximum amount of resource replenishments; or
combinations thereof.

18. The computer readable storage medium of claim 10, wherein the energy sources consumed by the activities are determined by performing sensitivity analysis of data obtained using a regression model describing energy savings in a building in terms of building characteristics, or a physical heat transfer model describing heat energy required to be provided to the building, or a combination thereof.

19. The computer readable storage medium of claim 18, wherein the regression model includes:
E_{j,elec}=β₀+β₁x₁+β₂x₂+β₃x₃+ . . . +ε_{elec}
E_{j,gas}=β₀+β₁x₁+β₂x₂+β₃x₃+ . . . +ε_{gas}
for predicting energy savings, E_{j,elect} and E_{j,gas}, wherein
E_{j,elect} represents electric (elect) energy saved in building j;
E_{j,gas} represents gas (gas) energy saved in building j;
xᵢ represents building's characteristic i;
βᵢ represents a coefficient value that each building characteristic xᵢ contributes to the energy usage in building j;
β₀ is a constant value contributing to building j's energy usage, which is not associated with building characteristics.

20. The computer readable storage medium of claim 18, wherein the physical heat transfer model includes:
$$\begin{matrix}{Q}_{sys} = ( {h}_{q , wall} {A}_{wall} + {h}_{q , roof} {A}_{roof} + {h}_{q , win} {A}_{win} + {\dot{m}}_{inf} {C}_{p} ) \\ {\int }_{{t}_{0}}^{{t}_{1}} {( {T}_{z} - {T}_{amb} ( τ ) )}^{+} d τ \\ = ( \frac{{A}_{wall}}{{R}_{wall}} + \frac{{A}_{roof}}{{R}_{roof}} + \frac{{A}_{window}}{{R}_{window}} + {\dot{m}}_{inf} {C}_{p} ) \\ {\int }_{{t}_{0}}^{{t}_{1}} {( {T}_{z} - {T}_{amb} ( τ ) )}^{+} d τ\end{matrix}$$
wherein,
Q_{sys}, represents heat energy required to be provided to a building;
h_{q,wall}, h_{q,roof}, h_{q,win}, \dot{m}_{inf} denote heat transfer coefficients for wall, roof, windows and infiltration of outside air into the building, respectively;
A_{wall}, A_{roof}, A_{win} denote area of wall, roof and window in the building, respectively;
Cₚ, T_{z}, T_{amb} denote specific heat of air inside building, temperature of inside of building (zone), and ambient (outside) temperature, respectively;
τ is an integration variable;
R_{wall}, R_{roof}, R_{win} denote heat resistance coefficients of wall, roof and window, respectively.

21. A system for scheduling of energy consuming activities in a building, comprising:
a processor;
a module operable to execute on the process and further operable to receive a plurality of activities to schedule in a building, the activities which consume energy from multiple sources having different generation and storage modes and price structures, the module further operable to receive one or more constraints associated with the activities, energy sources consumed by the activities, and cost of the energy sources, the module further operable to solve an objective function that optimizes energy cost associated with performing the activities based on the received plurality of activities, the energy sources consumed by the activities, and subject to the one or more constraints, the module further operable to determine a schedule of the activities based on the solved objective function.

22. The system of claim 21, wherein the objective function is solved to minimize green house gas emitted by the activities, to optimally utilize reservoir-type energy sources integrated with grid-type energy sources, or to minimize the energy cost, or combinations thereof.

23. The system of claim 24, wherein the module is further operable to determine a schedule of procurement of reservoir-type energy sources that minimizes the energy cost based on the solved objective function.

24. The system of claim 24, wherein the module is further operable to determine a schedule of generation of local energy sources that minimizes the energy cost based on the solved objective function.

25. The system of claim 21, wherein the energy sources consumed by the activities are determined by performing sensitivity analysis of data obtained using a regression model describing energy savings in a building in terms of building characteristics, or a physical heat transfer model describing heat energy required to be provided to the building, or a combination thereof.
